(19) United States
(12) Patent Application Publication
(10) Pub. No.: US 2025/0298977 A1
(43) Pub. Date: Sep. 25, 2025

(54) METHOD TO CATEGORIZE A WEBPAGE OR WEBSITE VIA HTML TOKENIZATION AND ANALYSIS WITH A LARGE LANGUAGE MODEL

(71) Applicant: Lenovo Enterprise Solutions (Singapore) Pte Ltd, Singapore (SG)

(72) Inventors: Scott Li, Cary, NC (US); Robert J Kapinos, Durham, NC (US); Russell S VanBlon, Raleigh, NC (US); Robert James Norton, Jr., Raleigh, NC (US)

(21) Appl. No.: 18/611,904

(22) Filed: Mar. 21, 2024

(51) Int. Cl. G06F 40/284; G06F 16/908

(52) U.S. Cl. CPC G06F 40/284; G06F 16/908

(57) ABSTRACT

A computer program product and method include operations including accessing HTML code from one or more webpages, tokenizing the HTML code to form one or more HTML tokens, submitting each HTML token to a large language model, and obtaining a token content description for each HTML token from the large language model. The operations further include determining, for each of the one or more webpages, whether to rendered the HTML code on the web browser based on the token content descriptions of the HTML tokens formed for the HTML code from the one or more webpages.

### BACKGROUND

The present disclosure relates to methods of identifying the content of a webpage or website.

### BACKGROUND OF THE RELATED ART

Web filtering can be implemented through the use of an allowlist of domains (also known as a “whitelist”) or a denylist of domains (also known as a “blacklist”). An allowlist and a denylist each serve a specific purpose. When relying solely on a denylist of domains, certain specified websites or online activities can be blocked to prevent access. However, a denylist may pose challenges when attempting to block access to a specific type of content without affecting access to other types of content or resources. For example, using a denylist to restrict a child's access to Google Doodle games may also block access to Google Classroom, which is an essential educational tool. In such cases, utilizing an allowlist may be more practical. By allowing access to only pre-approved domains using an allowlist, the child can still access the educational resources of Google Classroom while restricting access to Google Doodle games.

However, even relying solely on allowlist filtering has its limitations. A parent with administrative privileges to a web filter on the computing device used by the child may face the challenge of constantly adding new domains and Uniform Resource Locators (URLs) to the allowlist as the child has need for access to additional websites and resources. In the case of Google Classroom, where teachers frequently share different links and materials, the parent may need to frequently update the allowlist to accommodate access to these additional websites and resources. This constant updating of the web filter can be time-consuming and inconvenient, especially if multiple children are involved. Moreover, it may not be feasible for a parent to constantly monitor and keep up with the ever-expanding landscape of online content.

### BRIEF SUMMARY

Some embodiments provide a computer program product comprising a non-volatile computer readable medium and non-transitory program instructions embodied therein, the program instructions being configured to be executable by a processor to cause the processor to perform operations. The operations comprise accessing HTML code from one or more webpages, tokenizing the HTML code to form one or more HTML tokens, submitting each HTML token to a large language model, and obtaining a token content description for each HTML token from the large language model. Still further, the operations comprise determining, for each of the one or more webpages, whether to rendered the HTML code on the web browser based on the token content descriptions of the HTML tokens formed for the HTML code from the one or more webpages.

Some embodiments provide a computer program product comprising a non-volatile computer readable medium and non-transitory program instructions embodied therein, the program instructions being configured to be executable by a processor to cause the processor to perform operations. The operations may comprise accessing HTML code from one or more webpages, tokenizing the HTML code to form one or more HTML tokens for each of the webpages, submitting each HTML token to a large language model, obtaining a token content description for each HTML token from the large language model, receiving a search query for webpages that relate to a target content, and providing search results identifying webpages having one or more HTML tokens for which the token content description most closely satisfies the search query. These operations may be performed by a search engine with a web crawler for proactively accessing webpages, tokenizing the HTML code, submitting the HTML tokens to the LLM, and obtaining token content descriptions to facilitate indexing. Subsequently, when the search engine receives a search query, the search engine may provide search results identifying webpages having one or more HTML tokens for which the token content description most closely satisfies the search query.

### BRIEF DESCRIPTION OF THE SEVERAL VIEWS OF THE DRAWINGS

FIG. 1A is a diagram of a system including a computer with a web browser that filters webpages or websites based on the subject matter determined by a large language model.

FIG. 1B is a diagram illustrating the operation of the web browser.

FIG. 2A is a diagram of a system including a server hosting a search engine with a web crawler and an indexing module that indexes or categorizes webpages or websites based on the subject matter determined by a large language model.

FIG. 2B is a diagram illustrating the operation of the search engine.

FIG. 3 is diagram of a computer that may perform various operations in accordance with some embodiments.

FIG. 4 is a flowchart of a process for identifying the subject matter of a webpage using HTML tokenization and a large language model.

FIG. 5 is an example of code for performing HTML tokenization.

FIG. 6 is a diagram illustrating how HTML code may be separated into HTML tokens.

### DETAILED DESCRIPTION

Some embodiments provide a computer program product comprising a non-volatile computer readable medium and non-transitory program instructions embodied therein, the program instructions being configured to be executable by a processor to cause the processor to perform operations. The operations comprise accessing HTML code from one or more webpages, tokenizing the HTML code to form one or more HTML tokens, submitting each HTML token to a large language model, and obtaining a token content description for each HTML token from the large language model. Still further, the operations comprise determining, for each of the one or more webpages, whether to rendered the HTML code on the web browser based on the token content descriptions of the HTML tokens formed for the HTML code from the one or more webpages.

HTML (HyperText Markup Language) is a text-encoding system for specifying the structure and formatting of a documents designed to be displayed in a web browser. Web browsers obtain HTML code from a web server and render the HTML code into a webpage. The HTML code may be supported by other technologies like CSS (Cascading Style Sheets) and scripting languages such as JavaScript. A HTML code or an HTML document may include both HTML tags and HTML elements. Most, though not all, HTML elements will span between a start tag and end tag, and may include text, images and the like. As an example of HTML syntax, an element that forms a paragraph of text may have a start tag “<p>” (i.e., the letter “p” between angle brackets) and an end tag “</p>” (i.e., the slash in “</p>” tag indicating that this tag marks the end of the paragraph). Elements may be embedded within other elements to form a tree structure.

A web browser is an application for accessing websites. Some well-known web browsers include Google Chrome, Microsoft Edge, Apple Safari and Mozilla Firefox. A user may request a webpage by entering a uniform resource locator (URL) into a web browser. The web browser then retrieves a page (file) from a web server and renders the page on a display screen coupled to the computer that is running the web browser. A webpage (or webpage) is a structured document having its own address and acting as a single retrieval unit. A plurality of webpages may be organized into a website, which links the webpages together under a common domain name.

“Tokenizing” or “tokenization” is the process of separating or segmenting an HTML document, page or website into a series of individual elements and tags, such as a text token including a text element, a JavaScript token include a Javascript element, an image token including an image element, or tag token including one or more HTML tags. HTML tokens that include elements may be referred to as “cell tokens”, whereas tokens that include tags may be referred to as “structural tokens.” Each token represents a specific part of the HTML structure that makes up a webpage. By tokenizing HTML, applications can analyze and manipulate the content or interactive functionality of webpages.

A large language model (LLM) is a probabilistic model of a natural language having the ability to achieve general-purpose language generation and understanding. An LLM builds this ability by learning statistical relationships from large training sets of text documents. LLMs are artificial neural networks, which is a branch of machine learning models inspired by the structure and network of neurons in a brain (i.e., a biological neural network).

Embodiments herein utilize HyperText Markup Language (HTML) tokenization and a large language model (LLM) together to characterize the content of a webpage, website or other delineated amount of HTML code. The content of a webpage or website may be segmented into HTML tokens that are input to an LLM. Tokenization enables more granular analysis and understanding of webpage content, facilitating accurate identification, characterization and categorization of various elements within a webpage or website. HTML tokenization allows LLMs to effectively process and interpret webpage content, leading to enhanced capabilities in website content analysis and classification tasks. For example, the HTML tokenization may improve the LLMs ability to identify specific categories, extract key information, or detect patterns and relationships.

The LLMs may be “multi-modal”, which means that the LLM is able to process tokens with multiple types of content. For example, the LLM may process a token regardless of whether the token contains text, image, audio, video, tags, or script. Specifically, the LLM may analyze text tokens to identify keywords or patterns that indicate the topic or theme of the webpage, analyze image tokens to identify graphics, logos, or specific types of images, analyze a script tokens (such as JavaScript tokens) to identify interactivity, dynamic features, or potential security risks. Accordingly, the LLM may receive tokens of various types and provide a content description of the token. By leveraging HTML tokenization and utilizing large language models, the characterization of webpages becomes more robust, enabling various applications to perform content filtering, content recommendation or substitution, personalization of user experiences, targeted advertising, and improved search engine results. This process for analyzing webpage content enhances our ability to understand and respond to the ever-evolving landscape of online content. For example, a search engine may response to a request for content by recommending content to a user and/or substituting content for the user that does not violate a filter criterion, such as a maturity level.

In one option, the HTML tokenization module may inform the LLM of the token type associated with each HTM token and the LLM may process the HTML tokens in some unique manner based on the token type. In another option, the LLM may process each HTML token without being informed of the token type. For example, the LLM may be multimodal and effectively process each token based on its content.

HTML tokenization can provide valuable information about the elements of HTML pages, such as text, images, and JavaScript code. By breaking down the HTML content into tokens, each representing a specific component, a large language model may efficiently determine the content of each token. This approach enables characterization and categorization of webpages based on the content of the elements and tags present. This approach also enables efficient and accurate classification of webpage categories. Furthermore, the approach preserves privacy as the tokenization process abstracts the actual content, reducing the risk of exposing sensitive information.

In some embodiments, the LLM may run in a cloud or on a local computer, such as the same user computer that is running a web browser with a content filter. A localized LLM may facilitate performance of the present methods of webpage characterization or categorization in real-time. In one example, the accessing, tokenizing, submitting, obtaining, and determining operations are performed in real-time in response to a user entering a uniform resource locator into a web browser. The large language model may be performed locally on the same computer as the web browser. Alternatively, the large language model may be a cloud application accessible over a network.

In some embodiments, the tokenization and content determination may be performed in real-time in some applications and performed proactively in other applications. Without limitation, some applications may operate in real-time. For example, a web filtering application may determine whether the URL entered by a user contains content that violates the filter criteria for the user. However, some other applications may operate proactively. For example, a search engine application may collect indexing information about webpages or websites in order to facilitate a subsequent search query.

The HTML tokens may be input to the LLM through any interface, such as an application programming interface (API). In applications that use a web browser, such as a web filter, the web browser may utilize a browser plug-in that provides the browser with the HTML tokenization functionality. Optionally, the browser plug-in may also include the communication interface with the large language model for providing the HTML tokens and the receiving of the content descriptions from the large language model. Accordingly, the browser plug-in may monitor or receive either the uniform resource locator (URL) input to the web browser or the HTML code associated with the uniform resource locator after the web browser has obtained the HTML code associated by the URL. After receiving HTML code from the web browser, tokenizing the HTML code, providing the HTML tokens to the LLM and receiving the content descriptions for the HTML tokens from the LLM, the browser plug-in may provide the content descriptions to the web filter for use in determining whether or not to allow the web browser to render the associated portion of the HTML code.

In some embodiments, the content descriptions for the HTML code associated with a plurality of HTML tokens may be collected and supplied to the LLM for the purpose of generating a summarized content description of the website, webpage or other delineated scope of HTML code.

In some embodiments, the operation of tokenizing the HTML code to form one or more HTML tokens may include separating the HTML code into a plurality of tokens, wherein each token has a token type selected from a predetermined plurality of token types. In one example, the predetermined plurality of token types may include one or more token types selected from text, script, image, video, sound and tags. Each token may represent an element of HTML structure.

In some embodiments, the operations may further comprise causing, for each of the one or more webpages, the large language module to provide a webpage content description based on the token content descriptions obtained for each HTML token formed for the HTML code from the webpage. In one option, the large language module may be multi-modal, such as a multi-modal large language module that is able to provide a token content description for text tokens, script tokens, image tokens and audio tokens.

In some embodiments, the operations may further comprise identifying a rating system including a plurality of ratings, where each rating has a rating description. A further operation may comprise causing, for each of the one or more webpages, the large language module to identify one of the plurality of ratings for which the rating description most closely represents the webpage content description. For example, the rating system could include a plurality of maturity ratings, wherein, for each maturity rating, the rating description identifies content that is appropriate for the maturity rating.

In some embodiments, a web filter or search engine may provide a plurality of predetermined subject matter categories and task the LLM with determining which subject matter category is the closest match to the content description for the HTML token, webpage, website or other delineated scope of HTML code. In one example, the web filter may provide a plurality of predetermined maturity levels, where each maturity level may be associated with a description of content that is appropriate for the maturity level, inappropriate for the maturity level, or both. Accordingly, the LLM may provide the web filter with a content description that includes the maturity level. In another example, the search engine may provide a plurality of predetermined subject matter categories and task the LLM with identifying the one or more subject matter categories that most closely match the content of the HTML token, webpage, website or other delineated scope of HTML code.

In one option, the operation of determining, for each of the one or more webpages, whether to rendered the webpage on the web browser based on the token content descriptions of the HTML tokens formed for the HTML code from the webpage may include accessing a predetermined denylist of content categories, and allowing the web browser to display the one or more webpages in response to there being no HTML tokens from the one or more webpages with a content category on the denylist. In another option, the operation of determining, for each of the one or more webpages, whether to rendered the webpage on the web browser based on the token content descriptions of the HTML tokens formed for the HTML code from the webpage may include accessing a predetermined allowlist of content categories, and allowing the web browser to display the one or more webpages in response to all of the HTML tokens from the one or more webpages having a content category on the allowlist.

In some embodiments, the operations may further comprise recommending, based on the content of one or more of the HTML tokens on a webpage, one or more alternative webpages that has content that is similar to the content of one or more of the HTML tokens. For example, a search engine may have determined that the alternative webpages contain content that is similar to the content of the HTML tokens on a selected webpage. Optionally, the content on the alternative webpage(s) may have one or more attribute that may be preferably to the user, such as having a different maturity rating, a greater amount of information, graphics or visual aids, a lower security risk, and the like.

In some embodiments, the operations may further comprise sending targeted advertising to the web browser, wherein the targeted advertising is selected based on the token content description of the one or more of the HTML tokens. For example, a web browser in which a user has entered a URL for a webpage having an article about hiking trails may be sent targeted advertising for hiking gear, such as trail shoes or water bottles.

In some embodiments, the operations may further comprise determining, for each of the one or more HTML tokens for a webpage, whether to rendered the HTML code that formed the HTML token on the web browser based on the token content description of the HTML token code. In other words, whether or not to render certain HTML code may be determined per individual token or group of tokens, not just at the granularity of a full webpage or website. The HTML code that is not rendered may be simply left out or replaced by alternative content or advertising. Some embodiments provide a computer program product comprising a non-volatile computer readable medium and non-transitory program instructions embodied therein, the program instructions being configured to be executable by a processor to cause the processor to perform operations. The operations may comprise accessing HTML code from one or more webpages, tokenizing the HTML code to form one or more HTML tokens for each of the webpages, submitting each HTML token to a large language model, obtaining a token content description for each HTML token from the large language model, receiving a search query for webpages that relate to a target content, and providing search results identifying webpages having one or more HTML tokens for which the token content description most closely satisfies the search query. These operations may be performed by a search engine with a web crawler for proactively accessing webpages, tokenizing the HTML code, submitting the HTML tokens to the LLM, and obtaining token content descriptions to facilitate indexing. Subsequently, when the search engine receives a search query, the search engine may provide search results identifying webpages having one or more HTML tokens for which the token content description most closely satisfies the search query.

The foregoing computer program products may further include program instructions for implementing or initiating any one or more aspects of the methods and systems described herein. Furthermore, method embodiments may include any one or more of the operations of the computer program product embodiments.

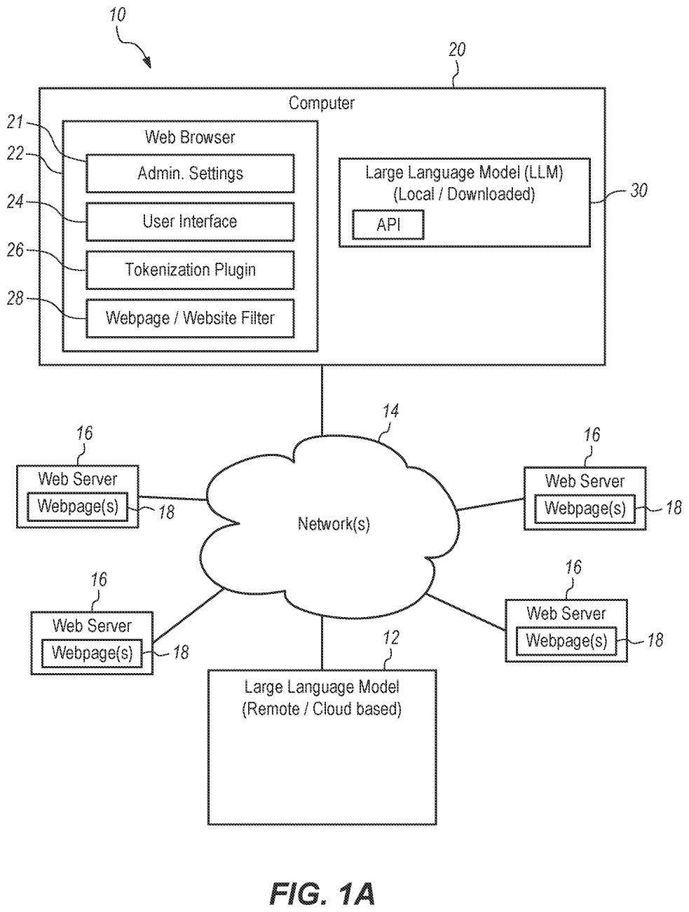

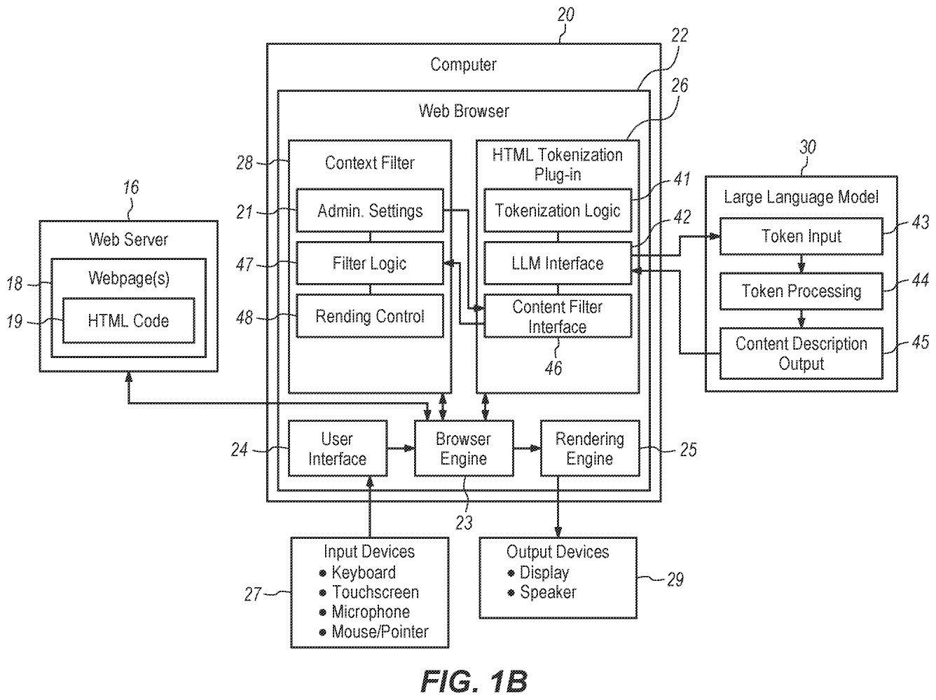

FIG. 1A is a diagram of a system 10 including a computer 20 with a web browser 22 that filters webpages or websites based on the subject matter content determined by a localized large language model 30. The web browser 22 includes a user interface 24 where, amount other things, the user may input a URL or a search query. The web browser 22 further includes a tokenization plug-in or module 26 for tokenizing HTML code from webpages and transferring the HTML tokens to the large language model 30. The large language model 30 then returns a content description for each token, where the content descriptions for a plurality of HTML tokens may be used by the webpage/website filter 28, along with administrative settings 21, to make determinations whether or not to render the HTML code associated with one or more of the tokens. Optionally, the large language model 30 may include an application programming interface (API) 32 to support interfacing with the web browser 22.

Although the large language model (LLM) 30 is illustrated as a localized LLM 30 running on the same computer 20 as the web browser 22, it is possible to implement embodiments where the LLM is run in the cloud. The cloud based LLM 12 may function the same as the localized LLM 30, but requires a remote connection over the network(s) 14 which is expected to involve a short delay or latency.

When a user inputs a URL into the user interface 24 of the web browser, the web browser 22 accesses a web server 16 that hosts the webpage(s) 18 associated with the URL and downloads the HTML code for that webpage to the computer 20. The HTML code may then be tokenized, the HTML tokens provided to the LLM, and a content description may be obtained from the LLM for use by the webpage/website/content filter in determining whether to render the HTML associated with each token.

FIG. 1B is a diagram further illustrating the operation of the web browser 22 in the context of the system 10 (only portions of the system 10 are shown). The web browser 22 includes a browser engine 23, the user interface 24, a rendering engine 25, the HTML tokenization plug-in or module 26 and the webpage/website/content filter 28. As shown, the computer 20 is coupled to one or more input devices 27, such as a keyboard, touchscreen, microphone and/or mouse/pointer, for providing input to the user interface 24 of the web browser 22. Conversely, the computer 20 is coupled to one or more output devices 29, such as a display screen or speaker, for outputting content received from the rendering engine 25. The browser engine 23 receives input through the user interface 24 and provides output through the rendering engine 25. The browser engine 23 is also in internal communication with the HTML tokenization plug-in 26 and the content filer 28. Still, the browser engine 23 may be in external communication with the web server 16 of obtain HTML code 19 associated with one or more webpage 18. For example, the computer 20 may have a network interface card (NIC; not shown) that enables the browser engine 23 to communicate with the web server 16 over one or more networks, such as the Internet.

In one embodiment, a user may utilize one of the input devices 27 to input a URL into the user interface 24. The browser engine 23 may obtain the URL from the user interface 24 and then access the HTML code 19 associated with the URL from the web server 16. After obtaining the HTML code 19, the browser engine 23 provides the HTML code to the HTML tokenization plug-in 26. HTML tokens generated by HTML tokenization logic 41 of the HTML tokenization plug-in 26 may be provided to the LLM interface 42 for forwarding to a token input module 43 of the LLM 30. The token processing module 44 of the LLM 30 then analyzes the HTML tokens and identifies a content description for each HTML token. The content description output module 45 then communicates the content descriptions to the LLM interface 42, which forward the content descriptions to the content filter 28 via the content filter interface 46. Alternatively, the content descriptions may be directly passed from the content description out 45 of the LLM 30 to the content filter 28.

In one option, the token processing 44 may be guided by one or more administrative settings 21, which may be provided to the LLM 30 via the content filter interface 46 and LLM interface 42. For example, if the administrative settings 21 are set to filter content based on one of three maturity settings, the LLM 30 may need descriptions of these three maturity settings in order to match a content description with the maturity setting that most closely matches the content description. Accordingly, the content description may be provided to the content filter 28 along with the corresponding maturity rating.

The content filter 28 includes filter logic 47 that receives the content description and any maturity rating or other responsive input. Using the content description, any provide ratings or categories (such as a maturity rating or subject matter category), and the administrative settings 21, the filter logic 47 may instruct the rendering logic 48 whether or not to render some, all or none of the HTML code associated with the webpage. If content is to be rendered, then content to be rendered is provided to the browser engine 23 that causes the rendering engine 25 to output the content on one or more of the output devices 29.

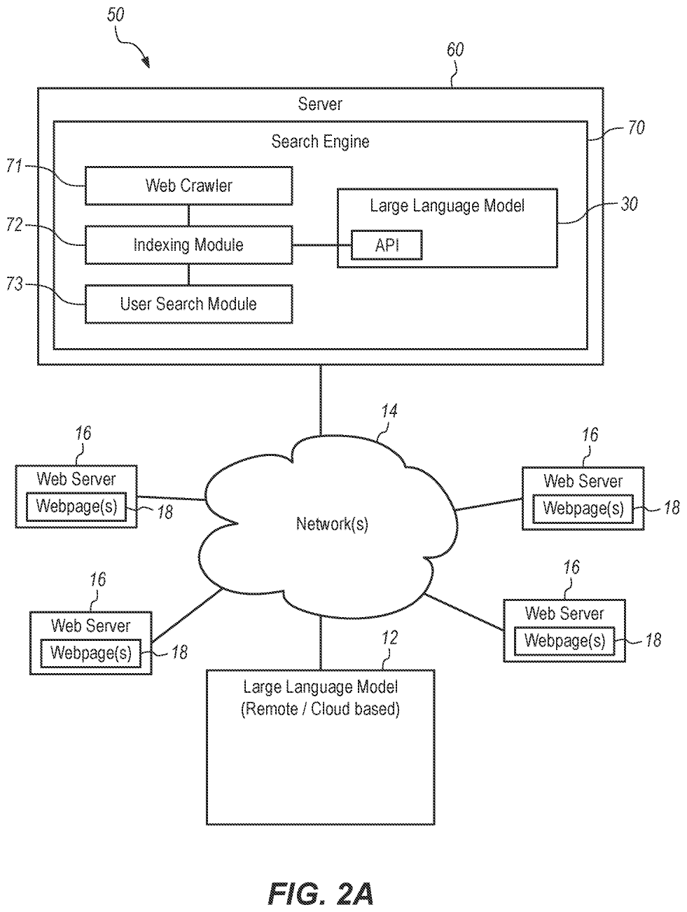

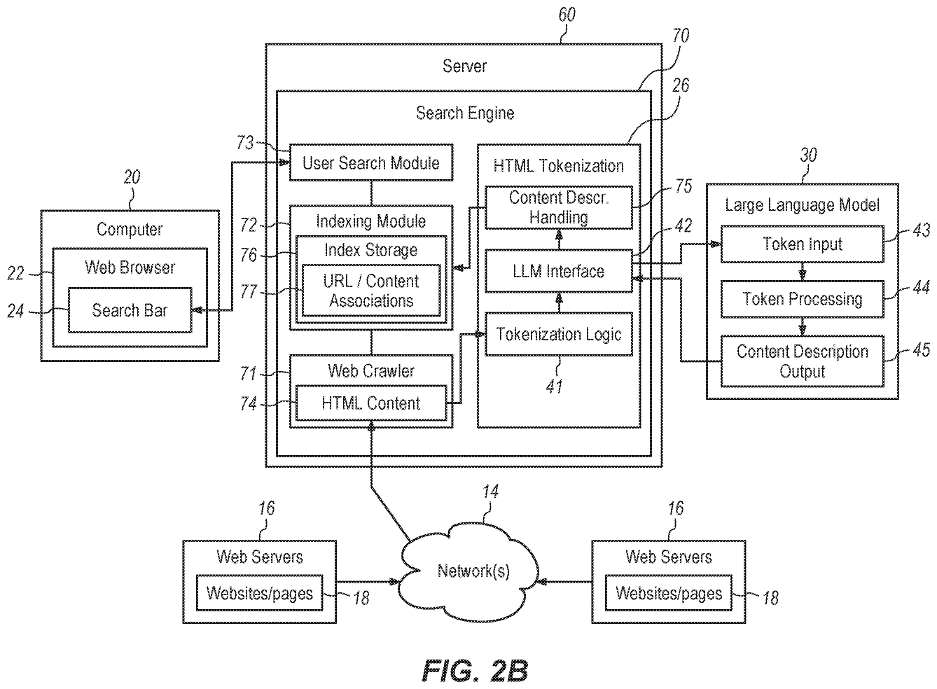

FIG. 2A is a diagram of a system 50 including a server 60 hosting a search engine 70 with a web crawler 71 and an indexing module 72 that indexes or categorizes webpages or websites based on the subject matter determined by a large language model 30. The search engine 70 also includes a user search module 73 that provides search results to a user query.

Similar to FIG. 1A, the system 50 further includes a network or networks 14 that connect the server 60 to a plurality of web servers 16 that host webpages 18. The web crawler 71 connects to each web server 16 to obtain HTML code for each webpage, or at least webpages representative of a given website, and process the HTML code as described herein to support indexing of the webpages. The search engine 70 may utilize a localized LLM 30 and/or a cloud based LLM 12. Various interfaces may be used to communicate with the LLM 30, 12, such as an application programming interface.

FIG. 2B is a diagram illustrating the operation of the search engine 70. The search engine 70 uses a web crawler 71 accessing HTML code from one or more webpages. For example, the web crawler 71 may utilize a network interface controller (NIC; not shown) to access the web servers 16 over the network(s) 14 and obtain the HTML code associated with the webpages or websites 18. This access may occur at any time but is typically proactive and may be ongoing in order to index the ever-changing content of new and existing webpages.

After obtaining the HTML code for a webpage 18, the web crawler 71 shares the HTML content 74 with the tokenization logic 41 of the HTML tokenization module 26. The tokenization logic 41 tokenizes the HTML code 74 to form one or more HTML tokens for each of the webpages 18, then submits each HTML token to the token input module 43 of the large language model 30 through the LLM interface 42. The LLM 30 then uses the token processing module 44 to analyze each token and generates a content description for each token or group of tokens. The content description output module 45 then provides the token content description for each HTML token to the LLM interface 42, which forwards the content description to the indexing module 72 via the content description handling module 75. The indexing module 72 may then store, in the index storage 76, URL and content associations 77 (i.e., a content description associated with each URL or content descriptions for the tokens generated from HTML code for the webpage at the URL). Optionally, the indexing module 72 could request the LLM 30 to generate a summary content description of the webpage and/or an entire website for storage in the associations 77.

The search engine 70 may subsequently receive a search query for a webpage that relates to a target content from the computer 20. For example, a user may input a search topic into the search bar 24 of the web browser 22 running on the computer 20, and the search topic may be transmitted to the user search module 73 of the search engine 70. The data 77 stored by the indexing module 72 may then use the search topic as an index into the data 77 to identify one or more webpages associated with a content description most closely satisfies the search query. The identified one or more webpages are then output to the web browser 22.

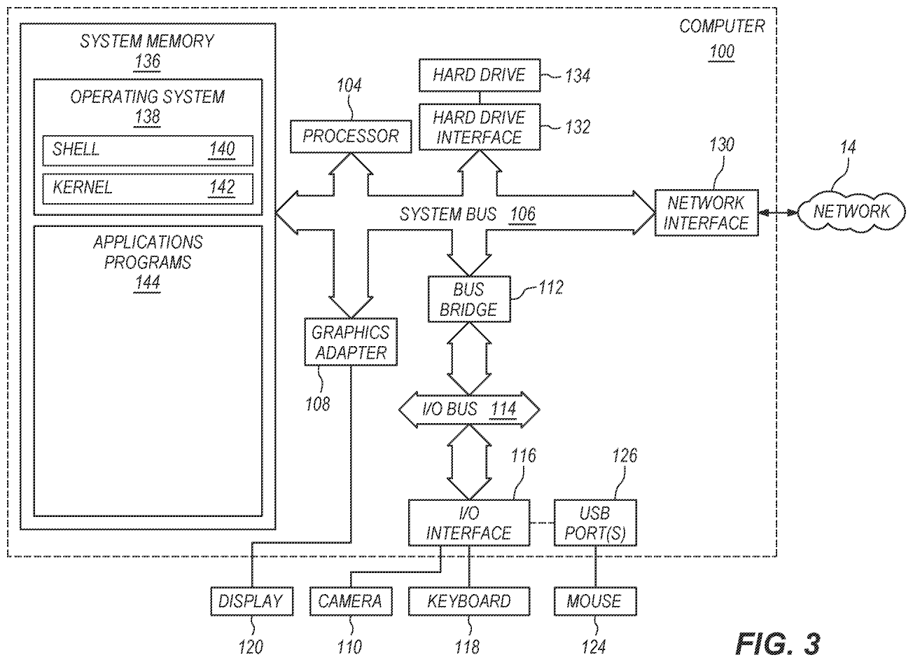

FIG. 3 is a diagram of a computer 100 that may be representative of the computer 20 running a web browser, the web servers 16, a server supporting the cloud based LLM 12, and/or the server 60 running a search engine in accordance with some embodiments. The computer 100 includes a processor unit 104 that is coupled to a system bus 106. The processor unit 104 may utilize one or more processors, each of which has one or more processor cores. A graphics adapter 108, which drives/supports the display 120, is also coupled to system bus 106. The graphics adapter 108 may, for example, include a graphics processing unit (GPU). The system bus 106 is coupled via a bus bridge 112 to an input/output (I/O) bus 114. An I/O interface 116 is coupled to the I/O bus 114. The I/O interface 116 affords communication with various I/O devices, including a camera 110, a keyboard 118 (such as a touch screen virtual keyboard), and a USB mouse 124 via USB port(s) 126 (or other type of pointing device, such as a trackpad). As depicted, the computer 100 is able to communicate with other devices over the network 14 using a network adapter or network interface controller 130.

A hard drive interface 132 is also coupled to the system bus 106. The hard drive interface 132 interfaces with a hard drive 134. In a preferred embodiment, the hard drive 134 communicates with system memory 136, which is also coupled to the system bus 106. System memory is defined as the lowest level of volatile memory in the computer 100. This volatile memory may include additional higher levels of volatile memory (not shown), including, but not limited to, cache memory, registers and buffers. Data that populates the system memory 136 may include an operating system (OS) 138 and application programs 144. Depending upon whether the computer 100 is serving as a computer or a server, the application programs 144 may include logic or applications to implement any of the embodiments disclosed herein.

The operating system 138 for the computer 100 may include a shell 140 for providing transparent user access to resources such as the application programs 144. Generally, the shell 140 is a program that provides an interpreter and an interface between the user and the operating system. More specifically, the shell 140 executes commands that are entered into a command line user interface or from a file. Thus, the shell 140, also called a command processor, is generally the highest level of the operating system software hierarchy and serves as a command interpreter. The shell may provide a system prompt, interpret commands entered by keyboard, mouse, or other user input media, and send the interpreted command(s) to the appropriate lower levels of the operating system (e.g., a kernel 142) for processing. Note that while the shell 140 may be a text-based, line-oriented user interface, embodiments may support other user interface modes, such as graphical, voice, gestural, etc.

As depicted, the operating system 138 also includes the kernel 142, which may include lower levels of functionality for the operating system 138, including providing essential services required by other parts of the operating system 138 and application programs 144. Such essential services may include memory management, process and task management, disk management, and mouse and keyboard management.

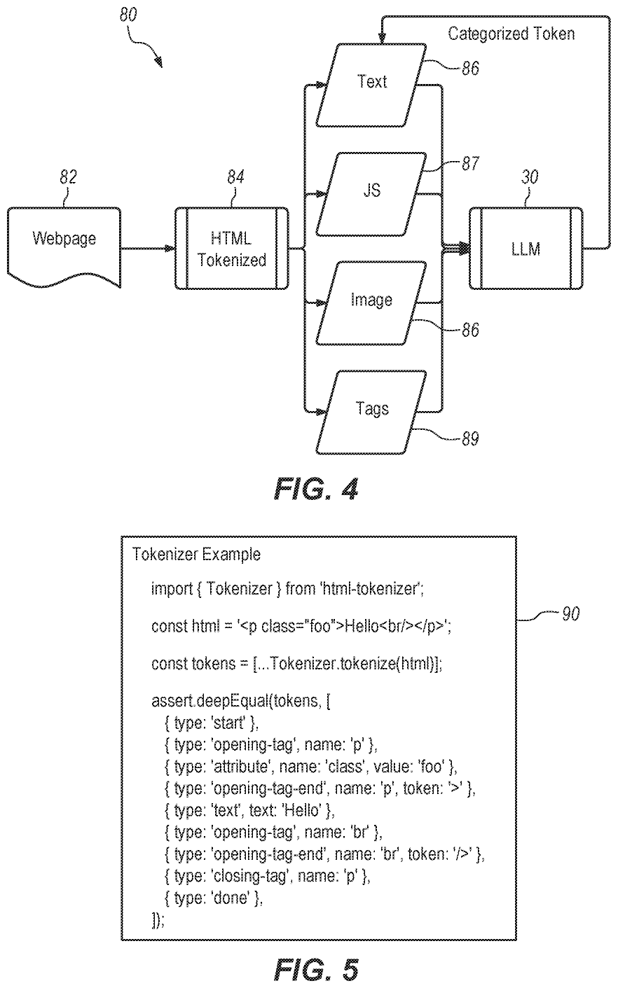

FIG. 4 is a flowchart of a process 80 for identifying the subject matter of a webpage 82. The HTML code from the webpage is accessed in operation 82 and HTML code is tokenized to form one or more HTML tokens in operation 84. In this embodiment, the tokens may include a text token 86 including a text element, a JavaScript token 87 including a Javascript element, an image token 88 including an image element, and/or a tag token 89 including one or more HTML tags. Each of the HTML tokens, regardless of the type of token 86-89, is input to the LLM 30 to generate a content description for that token. Optionally, the content descriptions output by the LLM may be returned to the LLM as a group to facilitate generation of a content description that is representative of the entire webpage and/or website.

FIG. 5 is an example of code 90 for performing HTML tokenization. This or similar code 90 may be representative of a tokenization plug-in 26 of a web browser 22 running on a computer 20 consistent with FIGS. 1A-B or the tokenization logic 41 of the search engine 70 performed by the server 60 consistent with FIGS. 2A-B.

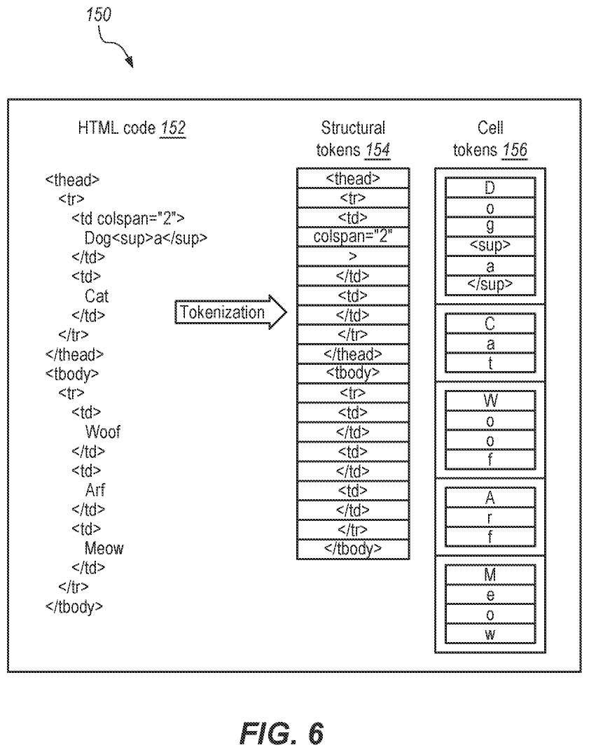

FIG. 6 is a diagram 150 illustrating how HTML code (see column 152) may be separated into HTML tokens. Although the scope of an individual token may vary, a preferred token may begin and end with a tag. For example, a “table data” tag “<td>” may mark the beginning of a token and the tag “</td>” may mark the ending of the token. Optionally, structural tokens (see column 154) may be separated from cell tokens (see column 156), where the structural tokens describe the HTML structure and the cell tokens describe the content or elements of each tag. While the granularity of the token may vary, herein the words “Dog^{a}”, “Cat”, “Woof”, “Arf” and “Meow” may each form a separate token. In other examples, the content of a single text token could be more than one word, a sentence, a paragraph or more.

As will be appreciated by one skilled in the art, embodiments may take the form of a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Any combination of one or more computer readable storage medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device. Furthermore, any program instruction or code that is embodied on such computer readable storage media (including forms referred to as volatile memory) that is not a transitory signal are, for the avoidance of doubt, considered “non-transitory”.

Program code embodied on a computer readable storage medium may be transmitted using any appropriate medium, including but not limited to wireless, wireline, optical fiber cable, RF, etc., or any suitable combination of the foregoing. Computer program code for carrying out various operations may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments may be described with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored on computer readable storage media is not a transitory signal, such that the program instructions can direct a computer, other programmable data processing apparatus, or other devices to function in a particular manner, and such that the program instructions stored in the computer readable storage medium produce an article of manufacture.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to limit the scope of the claims. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the embodiment.

The corresponding structures, materials, acts, and equivalents of all means or steps plus function elements in the claims below are intended to include any structure, material, or act for performing the function in combination with other claimed elements as specifically claimed. Embodiments have been presented for purposes of illustration and description, but it is not intended to be exhaustive or limited to the embodiments in the form disclosed. Many modifications and variations will be apparent to those of ordinary skill in the art after reading this disclosure. The disclosed embodiments were chosen and described as non-limiting examples to enable others of ordinary skill in the art to understand these embodiments and other embodiments involving modifications suited to a particular implementation.

What is claimed is:

1. A computer program product comprising a non-volatile computer readable medium and non-transitory program instructions embodied therein, the program instructions being configured to be executable by a processor to cause the processor to perform operations comprising:
accessing HTML code from one or more webpages;
tokenizing the HTML code to form one or more HTML tokens;
submitting each HTML token to a large language model;
obtaining a token content description for each HTML token from the large language model; and
determining, for each of the one or more webpages, whether to rendered the HTML code on the web browser based on the token content descriptions of the HTML tokens formed for the HTML code from the one or more webpages.

2. The computer program product of claim 1, wherein tokenizing the HTML code to form one or more HTML tokens includes:
separating the HTML code into a plurality of tokens, wherein each token has a token type selected from a predetermined plurality of token types.

3. The computer program product of claim 2, wherein each token represents an element of HTML structure.

4. The computer program product of claim 2, wherein the predetermined plurality of token types includes one or more token types selected from text, script, image and tags.

5. The computer program product of claim 2, wherein the predetermined plurality of token types includes one or more token types selected from text, script, image, video, sound and tags.

6. The computer program product of claim 2, the operations further comprising:
causing, for each of the one or more webpages, the large language module to provide a webpage content description based on the token content descriptions obtained for each HTML token formed for the HTML code from the webpage.

7. The computer program product of claim 6, wherein the large language module is multi-modal.

8. The computer program product of claim 7, wherein the multi-modal large language module is able to provide a token content description for text tokens, script tokens, image tokens and audio tokens.

9. The computer program product of claim 6, the operations further comprising:
identifying a rating system including a plurality of ratings, each rating having a rating description; and
causing, for each of the one or more webpages, the large language module to identify one of the plurality of ratings for which the rating description most closely represents the webpage content description.

10. The computer program product of claim 9, wherein the rating system includes a plurality of maturity ratings, wherein, for each maturity rating, the rating description identifies content that is appropriate for the maturity rating.

11. The computer program product of claim 6, the operations further comprising:
identifying a plurality of subject matter categories; and
causing, for each of the one or more webpages, the large language module to identify one of the plurality subject matter categories that most closely represents the webpage content description.

12. The computer program product of claim 11, wherein determining, for each of the one or more webpages, whether to rendered the webpage on the web browser based on the token content descriptions of the HTML tokens formed for the HTML code from the webpage includes:
accessing a predetermined denylist of content categories; and
allowing the web browser to display the one or more webpages in response to there being no HTML tokens from the one or more webpages with a content category on the denylist.

13. The computer program product of claim 11, wherein determining, for each of the one or more webpages, whether to rendered the webpage on the web browser based on the token content descriptions of the HTML tokens formed for the HTML code from the webpage includes:
accessing a predetermined allowlist of content categories; and
allowing the web browser to display the one or more webpages in response to all of the HTML tokens from the one or more webpages having a content category on the allowlist.

14. The computer program product of claim 1, wherein the accessing, tokenizing, submitting, obtaining, and determining operations are performed in real-time in response to a user entering a uniform resource locator into a web browser.

15. The computer program product of claim 14, wherein the large language model is performed locally on the same computer as the web browser.

16. The computer program product of claim 1, wherein the large language model is a cloud application accessible over a network.

17. The computer program product of claim 1, the operations further comprising:
recommending, based on the content of one or more of the HTML tokens on a webpage, one or more alternative webpages that has content that is similar to the content of one or more of the HTML tokens.

18. The computer program product of claim 1, the operations further comprising:
sending targeted advertising to the web browser, wherein the targeted advertising is selected based on the token content description of the one or more of the HTML tokens.

19. The computer program product of claim 1, the operations further comprising:
determining, for each of the one or more HTML tokens for a webpage, whether to rendered the HTML code that formed the HTML token on the web browser based on the token content description of the HTML token code.

20. A computer program product comprising a non-volatile computer readable medium and non-transitory program instructions embodied therein, the program instructions being configured to be executable by a processor to cause the processor to perform operations comprising:
accessing HTML code from one or more webpages;
tokenizing the HTML code to form one or more HTML tokens for each of the webpages;
submitting each HTML token to a large language model;
obtaining a token content description for each HTML token from the large language model;
receiving a search query for webpages that relate to a target content; and
providing search results identifying webpages having one or more HTML tokens for which the token content description most closely satisfies the search query.
